(19) United States
(12) Patent Application Publication
(10) Pub. No.: US 2014/0195977 A1
(43) Pub. Date: Jul. 10, 2014

(54) USER INTERFACE CONTENT PERSONALIZATION SYSTEM

(71) Applicants: Sherry S. Chang, El Dorado Hills, CA (US); Jon M. McDermott, Hillsboro, OR (US); David W. Stone, Folsom, CA (US)

(72) Inventors: Sherry S. Chang, El Dorado Hills, CA (US); Jon M. McDermott, Hillsboro, OR (US); David W. Stone, Folsom, CA (US)

(21) Appl. No.: 13/976,991

(22) PCT Filed: Apr. 11, 2012
(86) PCT No.: PCT/US12/33045

§ 371 Date: Jun. 27, 2013

(51) Int. Cl. G06F 17/30; G06F 3/0484

(52) U.S. Cl. CPC G06F 17/3053; G06F 3/04847
USPC 715/833; 707/732

(57) ABSTRACT

A user interface content personalization system is described. An apparatus may comprise a content personalization application operative on a processor circuit to present personalized content on a user interface. The content personalization application may comprise a content descriptor component operative to associate content with one or more content descriptors; a content search component operative to present search results on a user interface, the search results being selected from the content based on one or more search terms; a descriptor selection component operative to receive, by the transceiver, a descriptor selection enabled by a graphical user interface element accessible from the user interface; and a search results personalization component operative to generate personalized search results based on the descriptor selection, the search results personalization component to provide personalized search results on the user interface without re-entry of the one or more search terms. Other embodiments are described and claimed.

### BACKGROUND

Web pages accessible through the Internet now number in the billions. All of this content provides users with a wealth of information. However, it also presents difficulties in that users must sift through ever-increasing amounts of irrelevant information to locate the content they are actually seeking. A primary method for locating information is by entering search terms into a search engine, such as the popular search engine provided by Google™. Search engine results typically number in the hundreds of thousands and cover a wide range of content areas. For example, a search involving a technical support question for a particular software product may return content written for novices, experts, and multiple other levels of proficiency with the software product. As such, not only must users look through search results for content that addresses their problem, they must additionally look for content that matches their particular level of expertise.

For other types of web sites, such as news, movie, and online retail web sites, users are similarly inundated with content that is irrelevant to their needs and interests. For instance, a user seeking to purchase a digital camera for personal use through a retail web site may have to navigate through multiple content offerings for higher end, professional level digital cameras before locating products of interest. Therefore, one design goal for content providers is to develop content platforms capable of automatically and dynamically delivering personalized content to users. Consequently, techniques designed to personalize user interface content are desirable.

### BRIEF DESCRIPTION OF THE DRAWINGS

FIG. 1 illustrates an embodiment of a user interface content personalization system.

FIG. 2 illustrates an embodiment of a first operating environment for a content personalization application.

FIG. 3 illustrates an embodiment of a second operating environment for a content personalization application.

FIG. 4 illustrates an embodiment of a third operating environment for a content personalization application.

FIG. 5 illustrates an embodiment of content for a content personalization application.

FIG. 6 illustrates an embodiment of a fourth operating environment for a content personalization application.

FIG. 7 illustrates an embodiment of a fifth operating environment for a content personalization application.

FIG. 8 illustrates an embodiment of a first logic flow.

FIG. 9 illustrates an embodiment of a second logic flow.

FIG. 10 illustrates an embodiment of a third logic flow.

FIG. 11 illustrates an embodiment of a fourth logic flow.

FIG. 12 illustrates an embodiment of a computing architecture.

### DETAILED DESCRIPTION

Various embodiments are generally directed to content personalization techniques. Some embodiments are particularly directed to content personalization techniques that present refined search results responsive to a selection made at a graphical user interface (GUI) element. A user may personalize search results simply by making a selection on a user interface without having to re-enter search terms. Certain other embodiments are particularly directed to content personalization techniques that present content based on content attributes, user attributes, or some combination thereof. A user may access content better suited to their needs merely by being associated with user profile information that allows a content source to selectively present content corresponding to the user profile information. This significantly reduces the time and effort required to access relevant content, thereby enhancing user productivity, convenience, and experience.

With general reference to notations and nomenclature used herein, the detailed description which follows may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. These apparatus may be specially constructed for the required purpose or may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

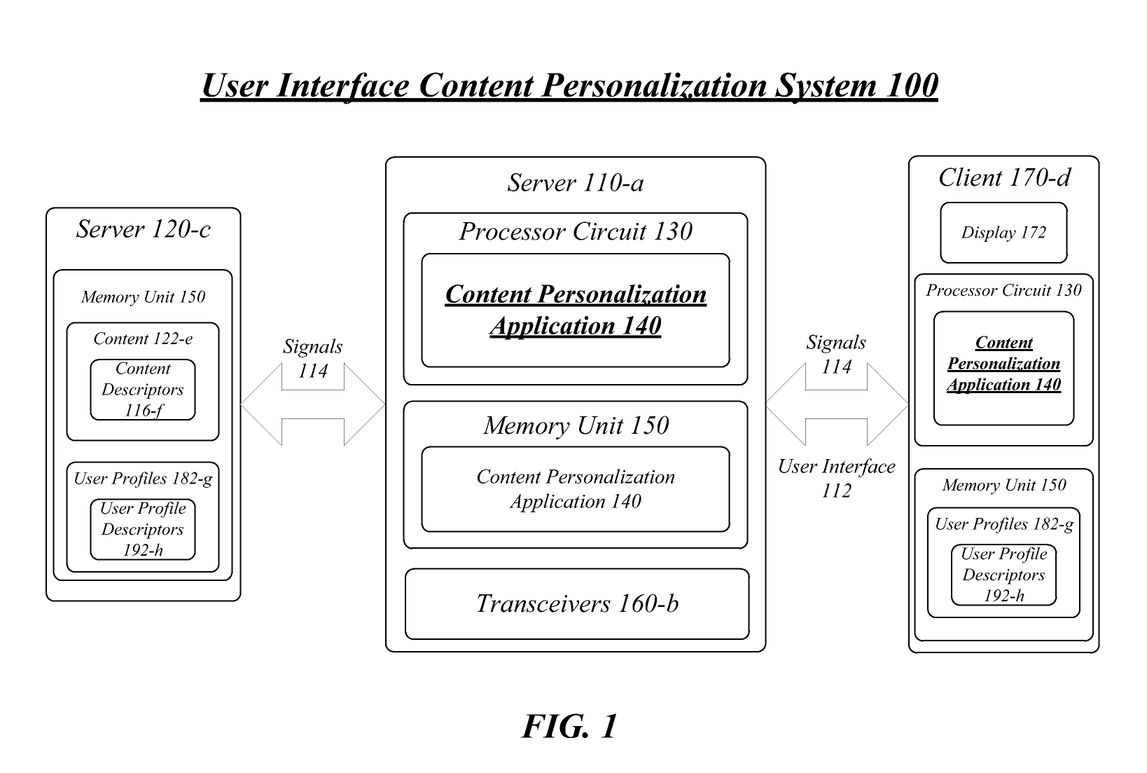

FIG. 1 illustrates a block diagram for a user interface content personalization system 100. In one embodiment, the user interface content personalization system 100 may comprise a computer-based system comprising a server 110-a. The server 110-a may comprise, for example, a processor circuit 130, a memory unit 150, and one or more transceivers 160-b. The server 110-a may further have installed a content personalization application 140. The memory unit 150 may store an unexecuted version of the content personalization application 140. Although the user interface content personalization system 100 shown in FIG. 1 has a limited number of elements in a certain topology, it may be appreciated that the user interface content personalization system 100 may include more or less elements in alternate topologies as desired for a given implementation.

It is worthy to note that “a,” “b,” “c” and similar designators as used herein are intended to be variables representing any positive integer. Thus, for example, if an implementation sets a value for a=5, then a complete set of servers 110-a may include servers 110-1, 110-2, 110-3, 110-4, and 110-5. The embodiments are not limited in this context.

In various embodiments, the user interface content personalization system 100 may comprise multiple computing devices, such as servers 110-a, 120-c and clients 170-d. Some examples of a computing device may include without limitation an ultra-mobile device, a mobile device, a personal digital assistant (PDA), a mobile computing device, a smart phone, a telephone, a digital telephone, a cellular telephone, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, machine, or combination thereof. The embodiments are not limited in this context.

In one embodiment, for example, servers 110-a and 120-c may be implemented as a web server and a network server, respectively, accessible over a network, such as the Internet. The client 170-d may be implemented as a desktop computer or a mobile device having a portable power supply and wireless communications capabilities, such as a laptop computer, handheld computer, tablet computer, smart phone, gaming device, consumer electronic, or other mobile device. The embodiments are not limited to these examples, however, and any servers 110-a, 120-c and clients 170-d may be used as desired for a given implementation. The servers 110-a may communicate with other computing devices 120-c, 170-d using communications signals 114 via the transceivers 160-b. The embodiments are not limited in this context.

In various embodiments, the user interface content personalization system 100 may comprise a processor circuit 130. The processing circuit 130 can be any of various commercially available processors, including without limitation an AMDD®, Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Core (2) Quad®, Core i3®, Core i50, Core i7®, Atom®, Itanium®, Pentium®, Xeon®, and XScale® processors; and similar processors. Dual microprocessors, multi-core processors, and other multi-processor architectures may also be employed as the processing circuit 130.

In various embodiments, the user interface content personalization system 100 may comprise a memory unit 150. The memory unit 150 may store, among other types of information, the content personalization application 140. The memory unit 150 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Content 122-e may comprise any defined set of electronic information, data, or content capable of being uniquely identified, presented by a user interface 112, or represented by a user interface element of a user interface 112. One example of a user interface 112 may comprise a graphical user interface (GUI). According to embodiments, content 122-e may be comprised of content descriptors 116-f as described in more detail below. One exemplary class of content 122-e may include without limitation software computer files, including application files (e.g., document files, word processing files, spreadsheet files, presentation files, etc.), system files (e.g., operating system files, library files, utility files, etc.), and multimedia content files (e.g., audio files, video files, audio/video files, picture files, image files, etc.). Other examples of content 122-e may include without limitation objects presented by a user interface 112, user interface elements, GUI elements, multimedia content (e.g., pictures, images, video, audio, graphics, etc.), software programs, views of software programs, application documents, application content (e.g., a paragraph from a word processing document or work sheet from a spreadsheet document), a web page, a web site, a uniform resource locator (URL) from a web browser, clipboard data, screenshots, device resource data (e.g., sensor data), and so forth. These are merely a few examples, and any type of defined set of electronic information, data, or content may comprise content 122-e as utilized in the user interface content personalization system 100. As illustrated in FIG. 1, the content 122-e may be located on servers 110-a or on a computing device accessible by the servers 110-a, such as one or more of servers 120-c, through the transceivers 160-b. The embodiments are not limited in this context.

Users may access content 122-e through a user interface 112 accessible by a display 172 of a client 170-d. The display 172 may comprise any digital display device suitable for the one or more clients 170-d. For instance, the display 172 may be implemented by a liquid crystal display (LCD) such as a touch-sensitive, color, thin-film transistor (TFT) LCD, a plasma display, a light emitting diode (LED) display, an organic light emitting diode (OLED) display, a cathode ray tube (CRT) display, or other type of suitable visual interface for displaying content 122-e on a user interface 112 to a user of the one or more clients 170-d. The display 172 may further include some form of a backlight or brightness emitter as desired for a given implementation.

In various embodiments, the servers 110-a may comprise one or more transceivers 160-b. Each of the transceivers 160-b may be implemented as wired transceivers, wireless transceivers, or a combination of both. In some embodiments, the transceivers 160-b may be implemented as physical wireless adapters or virtual wireless adapters, sometimes referred to as “hardware radios” and “software radios.” In the latter case, a single physical wireless adapter may be virtualized using software into multiple virtual wireless adapters. A physical wireless adapter typically connects to a hardware-based wireless access point. A virtual wireless adapter typically connects to a software-based wireless access point, sometimes referred to as a “SoftAP.” For instance, a virtual wireless adapter may allow ad hoc communications between peer devices, such as a smart phone and a desktop computer or notebook computer. Various embodiments may use a single physical wireless adapter implemented as multiple virtual wireless adapters, multiple physical wireless adapters, multiple physical wireless adapters each implemented as multiple virtual wireless adapters, or some combination thereof. The embodiments are not limited in this case.

The wireless transceivers 160-b may comprise or implement various communication techniques to allow the servers 110-a to communicate with other electronic devices, such as the servers 120-c and the clients 170-d. For instance, the wireless transceivers 160-b may implement various types of standard communication elements designed to be interoperable with a network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

In various embodiments, the servers 110-a may implement different types of transceivers 160-b. Each of the transceivers 160-b may implement or utilize a same or different set of communication parameters to communicate information between various electronic devices. In one embodiment, for example, each of the transceivers 160-b may implement or utilize a different set of communication parameters to communicate information between the servers 110-a and one or more remote devices, such as remote servers 120-c and remote clients 170-d. Some examples of communication parameters may include without limitation a communication protocol, a communication standard, a radio-frequency (RF) band, a radio, a transmitter/receiver (transceiver), a radio processor, a baseband processor, a network scanning threshold parameter, a radio-frequency channel parameter, an access point parameter, a rate selection parameter, a frame size parameter, an aggregation size parameter, a packet retry limit parameter, a protocol parameter, a radio parameter, modulation and coding scheme (MCS), acknowledgement parameter, media access control (MAC) layer parameter, physical (PHY) layer parameter, and any other communication parameters affecting operations for the transceivers 160-b. The embodiments are not limited in this context.

In one embodiment, for example, the transceiver 160-b may comprise a radio designed to communicate information over a wireless local area network (WLAN), a wireless metropolitan area network (WMAN), a wireless wide area network (WWAN), or a cellular radiotelephone system. The transceiver 160-b may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the transceiver 160-b may comprise a radio designed to communication information across data networking links provided by one or more cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented, and the embodiments are not limited in this context.

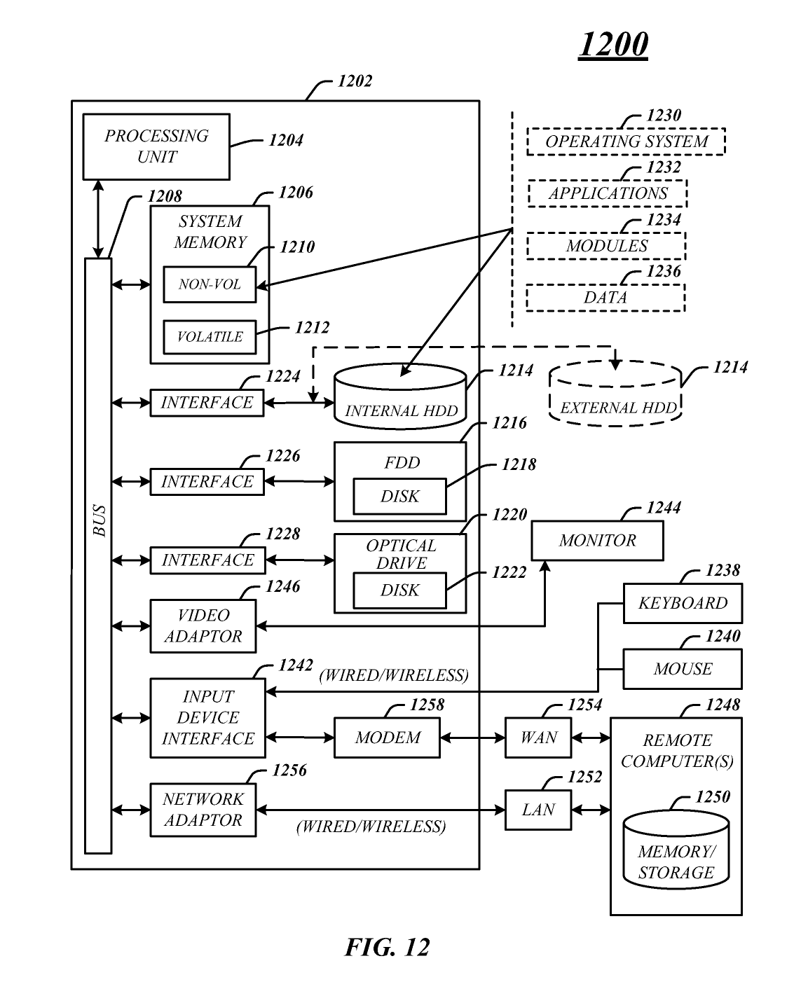

Although not shown, the servers 110-a, 120-c and clients 170-d may further comprise one or more device resources commonly implemented for electronic devices, such as various computing and communications platform hardware and software components typically implemented by a personal electronic device. Some examples of device resources may include without limitation a co-processor, a graphics processing unit (GPU), a chipset/platform control hub (PCH), an input/output (I/O) device, computer-readable media, display electronics, display backlight, network interfaces, location devices (e.g., a GPS receiver), sensors (e.g., biometric, thermal, environmental, proximity, accelerometers, barometric, pressure, etc.), portable power supplies (e.g., a battery), application programs, system programs, and so forth. Other examples of device resources are described with reference to exemplary computing architectures shown by FIG. 12. The embodiments, however, are not limited to these examples.

In the illustrated embodiment shown in FIG. 1, the processor circuit 130 may be communicatively coupled to the transceiver 160-b and the memory unit 150. The memory unit 150 may store a content personalization application 140 arranged for execution by the processor circuit 130 to present content 122-e to one or more clients 170-d through a user interface 112 via the transceivers 160-b. The servers 120-c and clients 170-d may implement similar elements as the servers 110-a, including a processor circuit 130, a memory unit 150, and transceivers 160-b. For example, servers 120-c may be comprised of a memory unit 150 storing content 122-e comprising content descriptors 116-f and user profiles 182-g comprising user profile descriptors 192-h. Clients 170-d may be comprised of a processor circuit storing an unexecuted version of the content personalization application 140 and a memory unit storing user profiles 182-g.

The content personalization application 140 may generally provide features to present personalized content on a user interface 112 based on certain attributes of the content and the users accessing the content. In one embodiment, a client 170-d may access the content personalization application 140 operating on a server 110-a utilizing a web browser application executing on the client 170-d including without limitation Microsoft® Internet Explorer®, Mozilla® Firefox®, Apple® Safari®, and Google Chrome™ browser applications. In another embodiment, a client 170-d may access the content personalization application 140 operating on a server 110-a utilizing a thin-client application and any associated thin-client hardware accessible by the client 170-d, including, but not limited to, ultra-thin client, web thin client, and mobile thin client implementations.

More particularly, in one embodiment, the content personalization application 140 allows a user to refine search results comprising content 122-e associated with one or more content descriptors 116-f by making a descriptor selection on a GUI element. As such, a user may obtain refined, personalized search results without requiring re-entry of search terms used to locate the original search results. In another embodiment, the content personalization application 140 associates content 122-e and user profiles 182-g with content descriptors 116-f and user profile descriptors 192-h, respectively. The content personalization application 140 may dynamically assign values to the descriptors 116-f, 192-h based on user interaction with the content 122-e. In a further embodiment, the content personalization application 140 presents personalized content 122-e to a user accessing a user interface 112 based on a comparison of values associated with content descriptors 116-f and values associated with user profile descriptors 192-h that correspond with the content descriptors 116-f. The user profile descriptors 192-h may be stored in user profiles 182-g associated with the user accessing the content 122-e. For instance, the content personalization application 140 may present a user interface 112 that only comprises content 122-e having a descriptor value that matches or is within a specified range of a corresponding descriptor value associated with one of the user profiles descriptors 192-h of a user interacting with the user interface 112.

A user may search content 122-e by entering one or more search terms at a client 170-d, for example, into a search engine as known by those having skill in the art and operative on or accessible by the servers 110-a, 120-c. The search results, comprising content 122-e associated with content descriptors 116-f, may be presented to the user through the user interface 112. In one embodiment, the content personalization application 140 may provide a GUI element on the user interface 112 configured to accept descriptor selections pertaining to the content descriptors 116-f associated with the content 122-e. For instance, the content 122-e may be associated with a rating descriptor having a numerical value ranging from 1-10 and indicating the technical difficulty of the content 122-e. The GUI element may therefore be configured to provide a user with the ability to select the technical difficulty range of the search results simply by making a selection (e.g., moving a selection object on a slider GUI element) and without having to re-enter search terms.

The content descriptors 116-f may be configured to provide a wide range of information pertaining to the content 122-e. In one embodiment, the content descriptors 116-f may comprise content ratings, including, but not limited to, ratings indicative of technical level, user popularity, or a quality rating (e.g. restaurant quality rating system) of the content 122-e. In another embodiment, the content descriptors 116-f may classify the content 122-e and user profiles 182-g into one or more categories, such as genre, technical specialty, or preferred quality level categories. Specific values may be assigned to the descriptors 116-f, 192-h, either automatically by the content personalization application 140 or by one or more content developers. For example, descriptors 116-f, 192-h may be assigned a number value within a specified range (e.g., 1-10) or a category title (e.g., movie genres such as “science fiction,” “drama,” “comedy,” “action,” and “adventure”). According to embodiments, values may be assigned to descriptors 116-f, 192-h based on user ratings of the content 122-e, descriptor values associated with users interacting with the content 122-e, intelligent rating systems, content developer or owner assignment, or some combination thereof.

Users may be associated with user profiles 182-g stored on servers 120-c, on clients 170-d, or some combination thereof. The content personalization application 140 may access the user profiles 182-g of users accessing content 122-e at the user interface 112 through communication signals 114 received at the transceivers 160-b. The user profiles 182-g may be comprised of one or more descriptors 192-h that correspond with descriptors 116-f being utilized by the content personalization application 140 to provide personalized content 122-e. For example, if a content descriptor 116-f relates to a technical difficulty rating of the content 122-e, such as on a scale of 1-10, a corresponding user profile descriptor 192-h may be comprised of a technical proficiency rating using the same scale and indicative of the technical difficulty of content 122-e preferred or previously viewed by the user associated with one of the user profiles 182-g. As such, carrying on this example, the content personalization application 140 may operate to present content 122-e to a user that has a technical difficulty rating that matches or is within a specified range of the user's technical proficiency, as indicated by a technical proficiency value of a user profile descriptor 192-h stored in one of the user profiles 182-g.

According to an embodiment, the user interface content personalization system 100 may implement the content personalization application 140 as a closed system. For instance, as a proprietary system comprised of one or more web sites presenting content 122-e through a user interface 112 accessible from clients 170-d. In one embodiment, access to the user interface 112 may be based on a configuration of the user profiles 182-g, such that only user profiles 182-g having certain identifying information (e.g., logon credentials) may access the content 122-e presented by the content personalization application 140 operating on the servers 110-a. For instance, users may register with or subscribe to the content personalization application 140 operating on the servers 110-a and may thereafter be associated with one of the user profiles 182-g comprising information including logon information and user profile descriptors 192-h. In another embodiment, the clients 170-d may execute a version (e.g., a client version or mobile application version) of the content personalization application through a processor circuit 130 resident on one of the clients 170-d. As such, the version of the content personalization application 140 operating on the servers 110-a may communicate with the version of the content personalization application 140 operating on the client to, inter alia, obtain access rights, user profiles 182-g, and user profile descriptors 192-h.

The user interface content personalization system 100 may operate to provide a system that allows for content personalization across user interfaces 112, for instance, across multiple web sites. In one embodiment, user profiles 182-g may be associated with multiple user profile descriptors 192-h relevant to specific user interfaces 112. A non-limiting example provides that user profile descriptors 192-h may be associated with a technical proficiency rating, a restaurant quality rating, a game level, and one or more categories of preferred movies (e.g., “action,” “comedy,” “adventure,” etc.). As such, a user may port one or more user profiles 182-g to multiple different websites (e.g., a technical support website, a restaurant search and rating website, a travel website, and a gaming website) and receive a personalized content experience at each site even if the sites have content 122-e associated with different content descriptors 116-f.

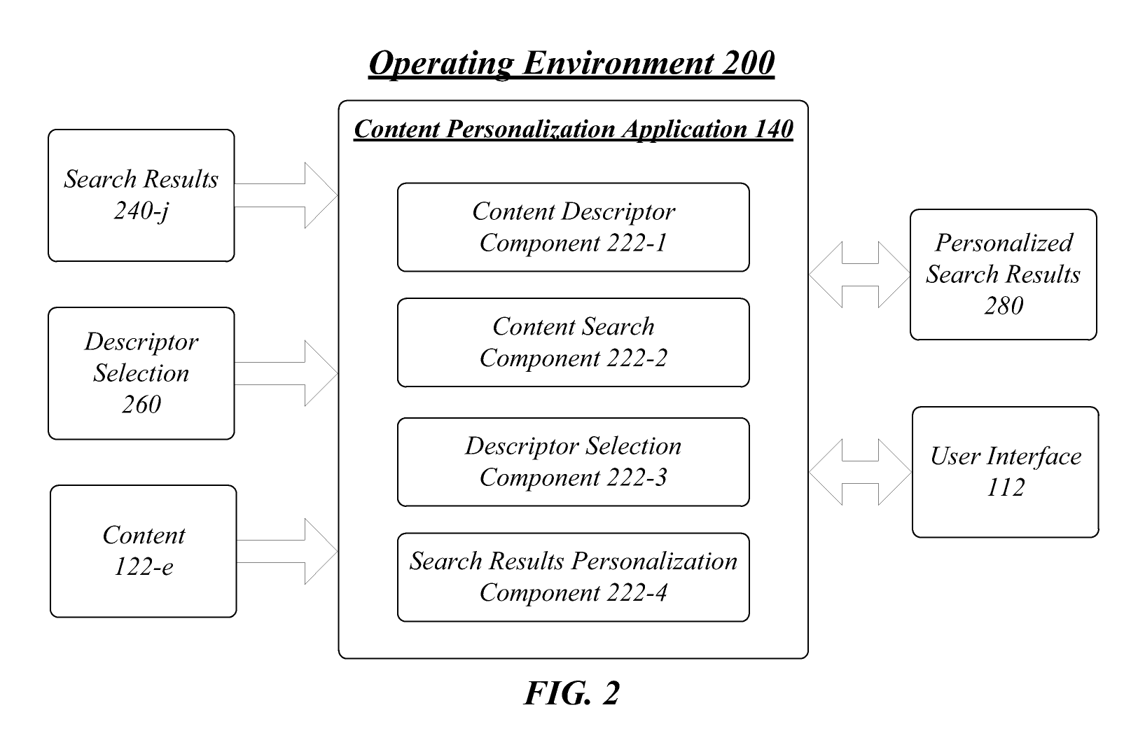

Particular aspects, embodiments and alternatives of the user interface content personalization system 100 and the content personalization application 140 may be further described with reference to FIG. 2.

FIG. 2 illustrates an embodiment of an operating environment 200 for the user interface content personalization system 100. More particularly, the operating environment 200 may illustrate a more detailed block diagram for the content personalization application 140.

As shown in FIG. 2, the content personalization application 140 may comprise various components 222-i. As used in this application, the term “component” is intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In the illustrated embodiment shown in FIG. 2, the content personalization application 140 may comprise a content descriptor component 222-1, a content search component 222-2, a descriptor selection component 222-3, and a search results personalization component 222-4. Although the content personalization application 140 shown in FIG. 2 has only four components in a certain topology, it may be appreciated that the content personalization application 140 may include more or less components in alternate topologies as desired for a given implementation. The embodiments are not limited in this context.

The content descriptor component 222-1 may generally associate content 122-e with content descriptors 116-f having values that operate to classify the various content offerings. For instance, the content 122-e may be comprised of web pages configured using one or more markup languages, such as the 5^{th} major revision to the hypertext markup language (HTML5) or the extensible markup language XML as defined by the World Wide Web Consortium (W3C). The content 122-e stored on the servers 110-a, 120-c may be accessed by the content personalization application 140 utilizing a web browser application, including without limitation Microsoft® Internet Explorer®, Mozilla® Firefox®, Apple® Safari®, and Google Chrome™ browser applications. In one embodiment, the content descriptor component 222-1 may annotate or otherwise modify the content 122-e to include one or more content descriptors 116-f and associated values. For instance, the content descriptor component 222-1 may utilize metadata tags to specify one or more content descriptors 116-f. The metadata tags may be machine parsable, and may be accessible by browsers, search engines, and other web services.

The content search component 222-2 may generally present search results 230 on the user interface 112. The search results 240-j may consist, at least in part, on content 122-e associated with content descriptors 116-f and relevant to one or more search terms. The servers 110-a may execute, through the processor circuit 130, or have access to a search engine configured to accept search terms and locate content 122-e relevant to the search terms according to processes known to those having skill in the art. A user may perform a search and view the search results 240-j through a user interface 112 accessible through a display 172 coupled to a client 170-d.

The descriptor selection component 222-3 may generally receive a descriptor selection 260 from a GUI element selected from the user interface 112 at one of the clients 170-d. The descriptor selection may be transmitted to the servers 110-a through communication signals 114 received at the transceivers 160-b. The GUI element may be configured to provide selections corresponding to the values assigned to the content descriptors 116-f. For instance, if the content descriptors 116-f are assigned values ranging from 1-5, then the GUI element may provide selections for 1, 2, 3, 4, 5, and default (i.e., “no selection”). The descriptor selection component 222-3 may maintain an active descriptor value representing the current descriptor selection 260.

In one embodiment, the descriptor selection 260 may initially be determined based on a value of a user profile descriptor 192-h corresponding to the values of the content descriptors 116-f utilized to configure the GUI element. The content personalization application 140 may access the user profile 182-g of a user accessing the search results 240-j presented by the content search component 222-2, and obtain a value of the user profile descriptor 192-h corresponding to the content descriptor 116-f utilized to set the GUI element selections. An initial descriptor selection 260 may be made based on the value of the corresponding user profile descriptor 192-h. For example, a GUI element may be configured with selections 1, 2, 3, 4, and 5 corresponding to a quality rating associated with the content 122-e contained within the search results 240-j. If a user profile 182-g contains a value of 2 for the corresponding quality rating user profile descriptor 192-h, an initial descriptor selection 260 may be set to the value 2 and the search results 240-j may be personalized according to embodiments provided herein. However, if the user profile 182-g does not contain the corresponding user profile descriptor 192-h or does not have a value set for the corresponding user profile descriptor 192-h, the initial descriptor selection 260 may be set to a default (“no selection”) descriptor selection 260 or some other default value (e.g., the highest, lowest, or middle value). Accordingly, embodiments provide that the descriptor selection 260 may be made by a user at the user interface 112 or may be made automatically by the content personalization application 140 based on a value of a user profile descriptor 192-h corresponding to the values of the content descriptors 116-f utilized to configure the GUI element selections.

The search results personalization component 222-4 may generally refine the search results 240-j based on the active descriptor value maintained by the descriptor selection component 222-3 for presentation as personalized search results 280 on the user interface 112. According to embodiments, the search results personalization component 222-4 may be configured to refine search results 240-j based on any number of relationships between the active descriptor value and any value of content descriptors 116-f associated with the search results 240-j. In one embodiment, the active descriptor value may be a numeric value within a specified range such that only content having values of corresponding content descriptors 116-f equal to, less than, greater than, or some combination thereof may be presented as personalized search results 280. For instance, the search result content may be associated with one of the content descriptors 116-f having a value ranging from 1-5 and the descriptor selection component 222-3 may receive a descriptor selection 260 from the GUI element of 4. The search results personalization component 222-4 may present personalized search results 280 comprising content 122-e having a value for one of the content descriptors 116-f equal to or equal to or greater than (less than) 4.

The content personalization application 140, through the content descriptor component 222-1, content search component 222-2, descriptor selection component 222-3, and search results personalization component 222-4 may operate to provide personalized search results from a collection of original search results without re-entry of search terms utilized to obtain the original search results. For example, a user may perform a search for content 122-e relevant to the search terms “data center power consumption.” The original search results 240-j may be comprised of content 122-e ranging from introductory information involving general, fundamental concepts to advanced content, including complex research papers and product documentation. As such, a data center manager may want search results comprised of advanced content, while a novice may only want search results 240-j comprised of general, basic content. The content personalization application 140 may provide search result content associated with content descriptors 116-f indicating the technical level of the content as well as a GUI element configured to allow a user to select the technical level of the search results. Selection of a technical level via the GUI element may operate to personalize the search results to the selected technical level. As such, users having different technical proficiencies may personalize the original search results to a desired technical level without having to re-enter search terms.

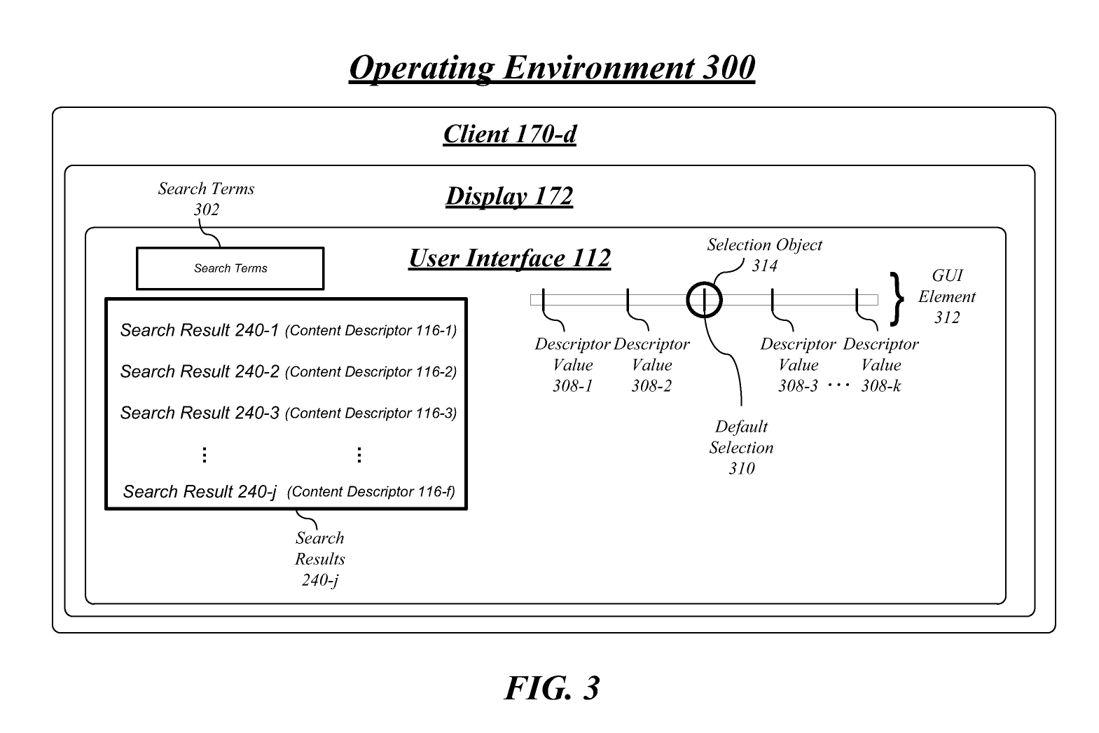

FIG. 3 illustrates an embodiment of an operating environment 300 for the user interface content personalization system 100. More particularly, the operating environment 300 may illustrate a user interface 112 comprising search results 240-j and a GUI element 312 configured to implement selection of descriptor values 308-k. The user interface 112 depicted in FIG. 3 may be accessible from a display 172 coupled to the clients 170-d.

In the illustrated embodiment shown in FIG. 3, the user interface 112 may comprise search terms 302 and search results 240-j comprising content 122-e relevant to the search terms 302. The search results 240-j may be associated with content descriptors 116-1, 116-2, 116-3, 116-f. A GUI element 312 accessible from the user interface 112 may be comprised of a selector object 314 and one or more selection options, including descriptor values 308-1, 308-2, 308-3, 308-k and a default selection 310. The descriptor values 308-k may correspond with one or more content descriptors 116-f or user profile descriptors 192-h associated with the content 122-e that makes up the search results 240-j. According to embodiments, the descriptor values 308-k displayed on the user interface may represent a subset of possible values for a particular content descriptor 116-f. For example, a content descriptor 116-f may have values in the range of 1-100, wherein all 100 values may not be included as a descriptor value 308-k due to size and operability constraints. As such, a subset of descriptor values 308-k (e.g., 0, 20, 40, 60, 80, and 100) may be accessible from the GUI element 312.

A user may select one of the descriptor values 308-k accessible from the GUI element 312 by setting the selector object 314 to a particular selection option contained within the available descriptor values 308-k. As previously described with reference to FIGS. 1 and 2, the content personalization application 140 may present search results 240-j corresponding to the selection of one of the descriptor values 308-k. However, FIG. 3 illustrates a first case where the GUI element 312 is set to a default selection 310 such that all search results 240-j relevant to the search terms 302 are presented on the user interface 112. As such, in the first case illustrated in FIG. 3, the search results 240-j have not been personalized based on the content descriptors 116-f.

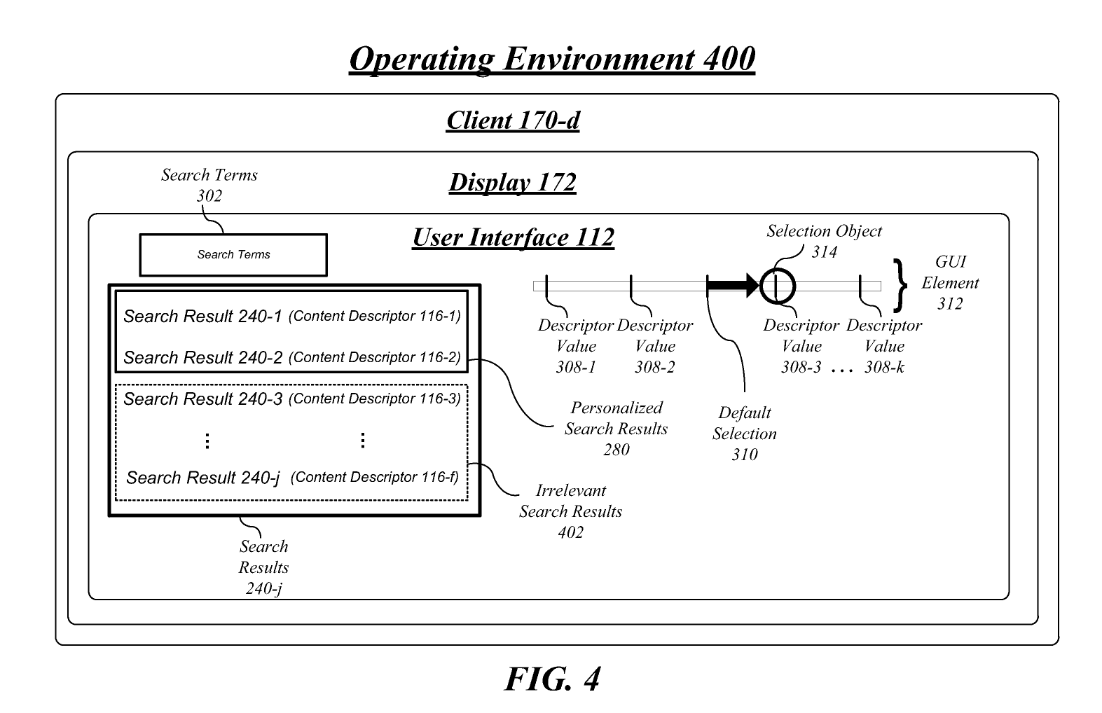

FIG. 4 illustrates an embodiment of an operating environment 400 for the user interface content personalization system 100. More particularly, the operating environment 400 may illustrate a user interface 112 comprising personalized search results 280 as selected at a GUI element 312 configured to descriptor values 308-k corresponding to content descriptors 116-f associated with content 122-e making up the search results 240-j. The user interface 112 depicted in FIG. 4 may be accessible from a display 172 coupled to one of the clients 170-d.

FIG. 4 illustrates a second case where the search results personalization component 222-4 generates personalized search results 280 based on the descriptor selection 260 of a descriptor value 308-3 made at the GUI element 312. The descriptor selection may be made by a user manually selecting a descriptor value 308-k via the GUI element 312 or may be made automatically based on a value of a user profile descriptor 192-h corresponding to the descriptor values 308-k. As shown in FIG. 4, the selector element 314 has been positioned on the GUI element 312, selecting descriptor value 308-3. The selection is communicated to the content personalization application 140 via communication signals 114 received at the transceivers 160-b. The search results personalization component 222-4 generates personalized search results 280 comprising a subset of the search results 240-j having a descriptor value 116-1, 116-2 that corresponds with the selected descriptor value 308-3. Irrelevant search results 402 are associated with a descriptor value 116-3, 116-f that does not correspond with the selected descriptor value 308-3 and, as such, are no longer presented on the user interface 112, as indicated by the dashed lines.

It is worth noting that although FIGS. 3-4 describe selection of descriptor values 308-k via a GUI element 312, embodiments are not limited to the particular configuration provided therein, as any suitable GUI element, including without limitation data entry, toggle, radio button, check box GUI elements, are contemplated herein.

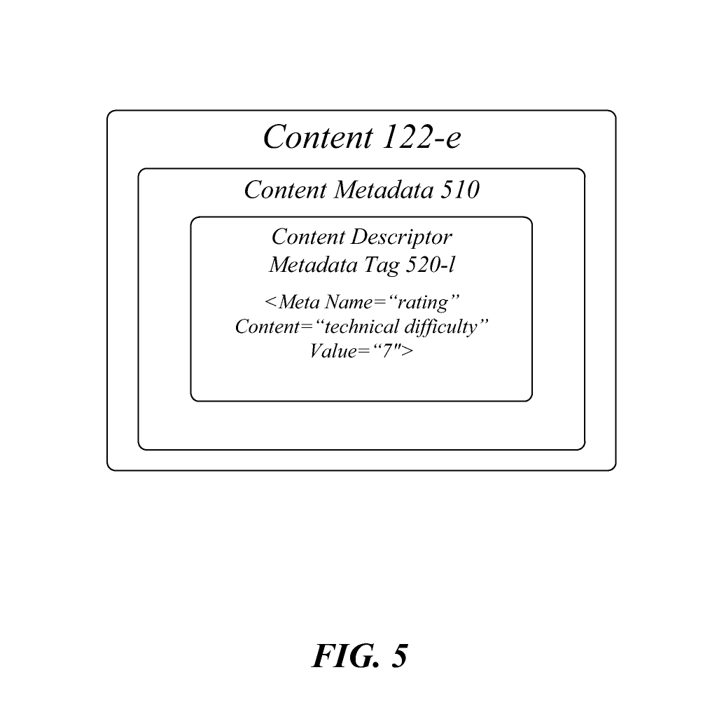

FIG. 5 illustrates a more detailed diagram exemplary of content 122-e comprising content descriptors 116-f according to an embodiment. As shown in FIG. 5, content 122-e may be comprised of metadata 510. The content descriptors 116-f may be specified utilizing one or more descriptor metadata tags 520-l. For instance, a descriptor metadata tag 520-1 may be comprised of the following: <Meta Name=“Rating” Content=“Technical Difficulty” Value=“7.” This descriptor metadata tag 520-1 may provide content descriptor values 116-f comprising a rating descriptor indicative of the technical difficulty of the content having a rating value of 7. User profile descriptors 192-h may be similarly configured as metadata in a user profile 182-g. Although the example content descriptor 116-f illustrated in FIG. 5 depicts a hypertext markup language metadata tag, such as an XML metadata tag, embodiments are not limited in this context, as any form of content descriptor 116-f or user profile descriptor 182-g capable of functioning according to embodiments is contemplated herein.

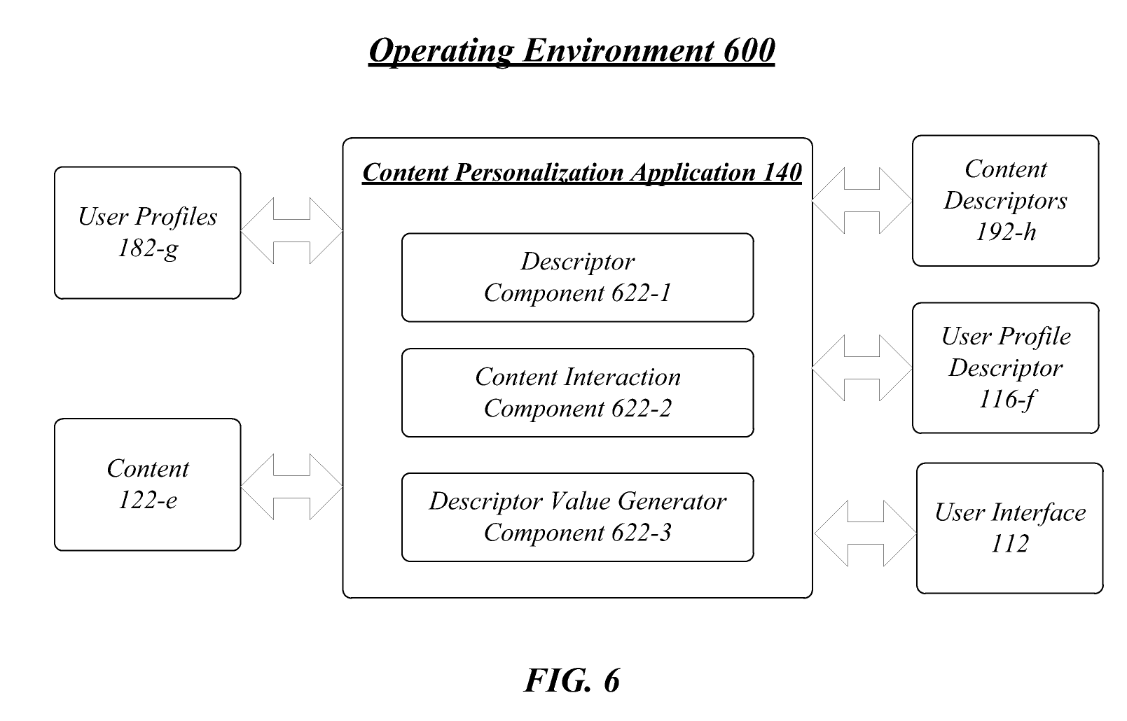

FIG. 6 illustrates an embodiment of an operating environment 600 for the user interface content personalization system 100. More particularly, the operating environment 600 may illustrate a more detailed block diagram for one embodiment of the content personalization application 140.

As shown in FIG. 6, the content personalization application 140 may comprise various components 622-m, including a descriptor component 622-1, a content interaction component 622-2, and a descriptor value generator component 622-3. Although the content personalization application 140 shown in FIG. 6 has only three components in a certain topology, it may be appreciated that the content personalization application 140 may include more or less components in alternate topologies as desired for a given implementation. The embodiments are not limited in this context.

The descriptor component 622-1 may generally associate content 122-e and user profiles 182-g with content descriptors 116-f and user profile descriptors 192-h, respectively. In general, the content descriptors 116-f may operate to classify the various content offerings and the user profile descriptors 192-h may operate to relate users with content 122-e so that the content personalization application 140 may present users with personalized content 122-e. For instance, as described hereinabove with reference to FIG. 2, the content descriptors 116-f may be comprised of ratings provided to classify the content 122-e according to a specific numerical range of rating values. In one embodiment, the ratings are indicative of a technical difficulty of the content 122-e. Another embodiment provides that the ratings may indicate a quality level associated with the content 122-e (e.g., a four star hotel rating system).

User profiles 182-g may be associated with user profile descriptors 192-h that correspond to content descriptors 116-f of content 122-e presented on a user interface 112 accessible by users associated with the user profiles 182-g, for example, via a display 172 coupled to a client 170-d. For instance, content 122-e may be associated with one of the content descriptors 116-f indicating a technical difficulty of the content 122-e on a scale of 1-10. As such, user profiles 182-g associated with users accessing the content 122-e may be associated with user profile descriptors 192-h indicating a technical proficiency (i.e., a preferred level of content technical difficulty) on a scale of 1-10. In this manner, the values associated with the content descriptors 116-f and the user profile descriptors 192-h may be compared for content personalization purposes according to embodiments disclosed herein.

The content interaction component 622-2 may generally function to generate content interaction information based on the content descriptors 116-f, the user profile descriptors 192-h, and user interaction with the content 122-e. Users associated with the user profiles 182-g comprising the user profile descriptors 192-h may interact with the content 122-e via a user interface 112 presented on a display 172 accessible by a client 170-d. In one embodiment, user interaction may comprise crowd averaging techniques that average content ratings provided by users accessing the content 122-e through the user interface 112. In another embodiment, user interaction may involve system learning based on user content interaction patterns (e.g., web site browsing patterns). For example, the content interaction component 622-2 may track the values of user profile descriptors 192-h associated with users interacting with the content 122-e to determine whether users having similar values for particular user profile descriptors 192-h prefer certain content 122-e. In a further embodiment, values of content descriptors 116-f may be tracked in relation to users interacting with the content 122-e in order to associate user profiles 182-g with particular values of content descriptors 116-f.

The descriptor value generator component 622-3 may generally assign values dynamically to the content descriptors 116-f and the user profile descriptors 192-h based on content interaction information obtained by the content interaction component 622-2. In one embodiment, the descriptor value generator component 622-3 may assign values to content descriptors 116-f based on crowd averages of content ratings provided by users interacting with the content 122-e through a user interface 112. For example, if the crowd average given by users of a particular content offering is 5 on a scale of 1-10, then the descriptor value generator component 622-3 may assign a value of 5 to a corresponding content descriptor 116-f. In another embodiment, values may be assigned to content descriptors 116-f based on values associated with user profile descriptors 192-h interacting with the content 122-e. For instance, the content interaction component 622-2 may provide content interaction information of user browsing patterns. A non-limiting example provides that user browsing patterns may indicate that users having a value of “novice” associated with a “expertise level” user profile descriptor 192-h may prefer certain content elements. As such, the descriptor value generator component 622-3 may use the content interaction information to assign a value of “novice” to the corresponding “expertise level” content descriptor 116-f. In a further embodiment, values for the content descriptors 116-f may be assigned initial values, for example, by a content developer or through intelligent content rating tools, when published, which may be adjusted according to embodiments configured to assign ratings to content descriptors based on user interaction with the content 122-e as disclosed herein.

In another embodiment, the descriptor value generator component 622-3 may assign values to user profile descriptors 192-h by aggregating the values of content descriptors 116-f of content 122-e accessed by users. For example, user profiles 182-g may be assigned a default value, such as a middle value of a descriptor range (e.g., 5 on a scale of 1-10). User interaction information generated by the content interaction component 622-2 may be used to determine values of content descriptors 116-f of content 122-e accessed by users interacting with the user interface 112. An embodiment provides that the values of content descriptors 116-f accessed by users may be used to provide an aggregate average of a user's preferred content descriptor value. For instance, a preferred technical difficulty level, quality rating, or category. For example, using a rating value scale from 1-10, user profiles 182-g may initially be assigned a default value for one of the user profile descriptors 192-h of 5. If users associated with the user profiles 182-g access content 122-e having a corresponding value of 7, then the average value associated with the user profile descriptors 192-h may be calculated as (5+7)/2=6. The descriptor value generator component 622-3 may continue to calculate an aggregate average for the corresponding user profile descriptors 192-h for each content access. In one embodiment, the descriptor value generator component 622-3 may assign a value to one of the user profile descriptors 192-h after a threshold of content accesses (e.g., 10) have been detected. In another embodiment, a default value is used as the value for one of the user profile descriptors 192-h for a user that is not associated with one of the existing user profiles 182-g until a threshold number of content accesses have been detected, and values of content descriptors 116-f are used to update the aggregate average value for one of the user profile descriptors 192-h of a user previously associated with one of the existing user profiles 182-g.

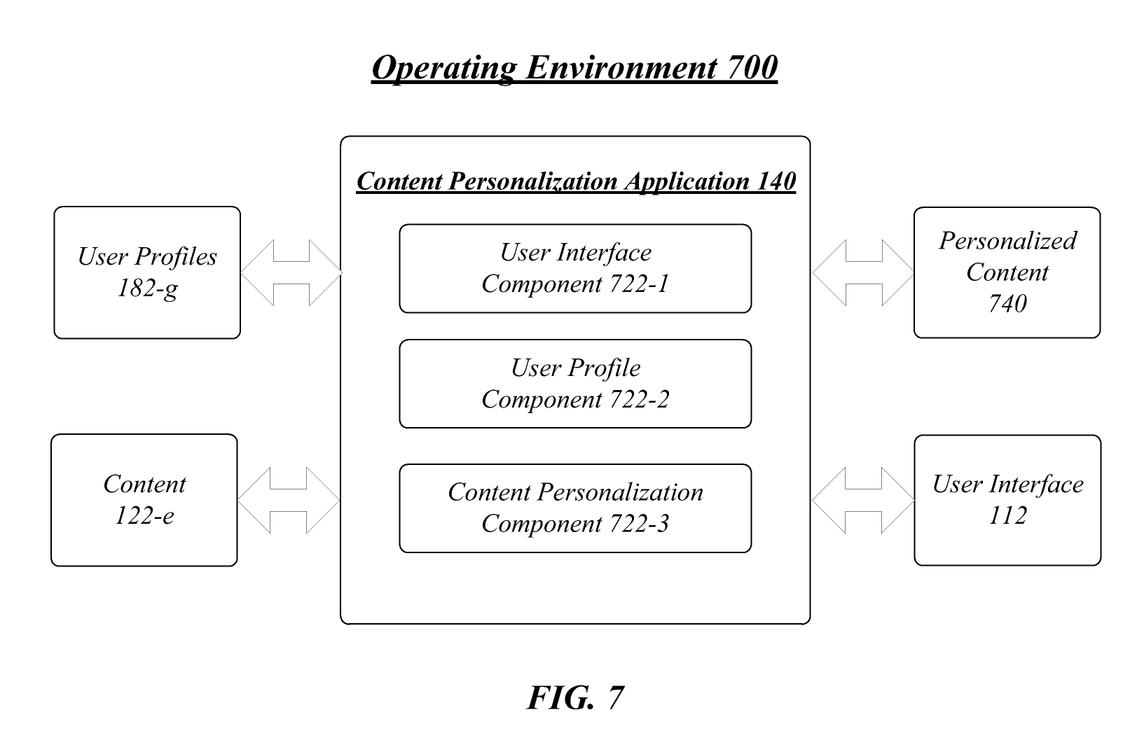

FIG. 7 illustrates an embodiment of an operating environment 700 for the user interface content personalization system 100. More particularly, the operating environment 700 may illustrate a more detailed block diagram for one embodiment of the content personalization application 140.

As shown in FIG. 7, the content personalization application 140 may comprise various components 722-n, including a user interface component 722-1, a user profile component 722-2, and a content personalization component 722-3. Although the content personalization application 140 shown in FIG. 7 has only three components in a certain topology, it may be appreciated that the content personalization application 140 may include more or less components in alternate topologies as desired for a given implementation. The embodiments are not limited in this context.

The user interface component 722-1 may generally present content 122-e associated with content descriptors 116-f on a user interface 112, for example, that is accessible through a display 172 coupled to a client 170-d. For instance, the user interface component 722-1 may present one or more web pages associated with content descriptors 116-f configured to indicate proficiency with software that is associated with a particular web site, such as a technical support web site. Content 122-e may be associated with content descriptors 116-f according to embodiments disclosed hereinabove. For instance, content descriptors 116-f may be comprised of descriptors indicative of a quality level associated with the content 122-e (e.g., restaurant rating system) assigned based on reviews of users interacting with the content 122-e through a user interface 112.

The user profile component 722-2 may generally receive user profiles 182-g stored at the servers 120-c or the clients 170-d through communication signals 114 received by the transceivers 160-b. For example, the user profile component 722-2 may receive one of the user profiles 182-g maintained at the servers 120-c or the clients 170-d through cookies, application files, or a user login profile used to access content 122-e identified through a user identification associated with the user profiles 182-g. In one embodiment, the user profile component 722-2 may query the user profiles 182-g to obtain user profile descriptors 192-h stored therein. In another embodiment, user profiles 182-g may be comprised of multiple user profile descriptors 192-h that may be relevant to content 122-e presented on one or more user interfaces 112. For example, user profiles 182-g may have one of the user profile descriptors 192-h configured to indicate a technical proficiency with a particular software application that is the subject of a proprietary technical support web site for the software application. The user profiles 182-g may additionally have one of the user profile descriptors 192-h configured to indicate a quality level of hotel preferred by an associated user. In this manner, users may be associated with one or more user profiles 182-g that may be ported to different user interfaces 112 that utilize a subset of the user profile descriptors 192-h contained in the user profiles 182-g. As such, a user may interact with multiple different user interfaces 112 (e.g., web sites, software applications) configured according to embodiments and receive personalized content at each user interface 112, without having to maintain one of the user profiles 182-g for each particular user interface 112.

The content personalization component 722-3 may generally present personalized content 740 presented on a user interface 112 based on a comparison between values associated with the content descriptors 116-f and corresponding user profile descriptors 192-h. For instance, the content personalization component 722-3 may operate to match content 122-e having values for the content descriptors 116-f that match values for corresponding user profile descriptors 192-h. In one embodiment, a match may mean that the values associated with the content descriptors 116-f are equal to or are within a specified range of the values associated with the corresponding user profile descriptors 192-h. For example, content descriptors 116-f and user profile descriptors 192-h may be associated with a value indicative of a quality rating for restaurants. A user associated with one of the user profiles 182-g may have a quality rating value of 3 on a scale of 1-4 associated with one of the user profile descriptors 192-g. When a user interacts with a user interface 112 comprised of a web site having local restaurant content configured according to embodiments, the content personalization component 722-3 may arrange, present, highlight, or otherwise personalize the local restaurant content such that content 122-e having a quality rating value of 3 may be automatically and more efficiently presented to the user.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

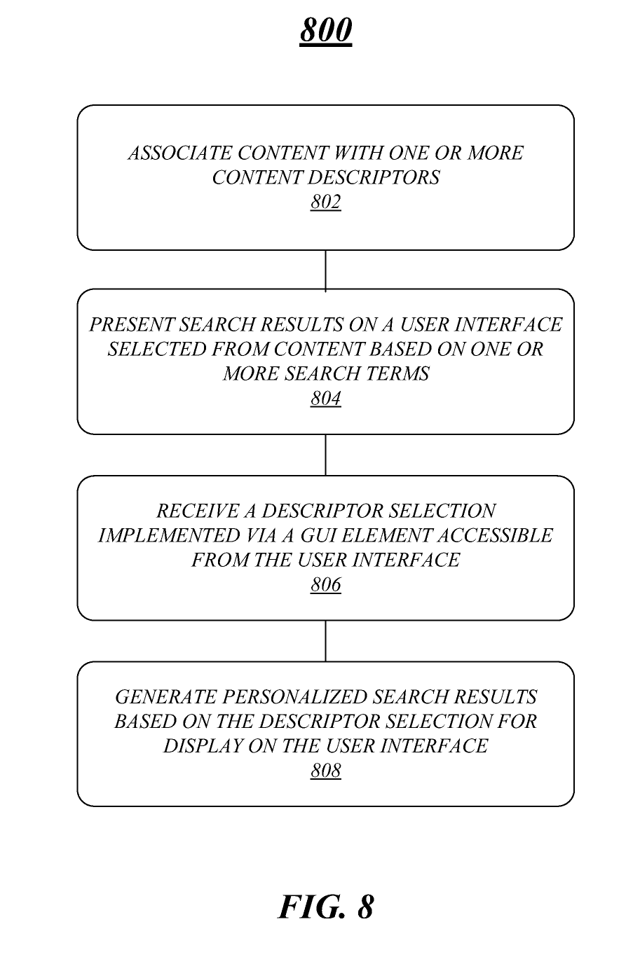

FIG. 8 illustrates one embodiment of a logic flow 800. The logic flow 800 may be representative of some or all of the operations executed by one or more embodiments described herein. For example, the logic flow 800 may illustrate operations performed by the user interface content personalization system 100.

In the illustrated embodiment shown in FIG. 8, the logic flow 800 may associate content with one or more content descriptors at block 802. For example, the content descriptor component 222-1 may associate content 122-e with one or more content descriptors 116-f.

The logic flow 800 may present search results on a user interface selected from content based on one or more search terms at block 804. For example, the content search component 222-2 may present search results 240-j on a user interface 112 comprising content 122-e relevant to search terms 302. The user interface 112 may be accessible to users through a display 172 accessible from a client 170-d.

The logic flow 800 may receive a descriptor selection implemented via a GUI element accessible from the user interface at block 806. For example, the descriptor selection component 222-3 may receive a descriptor selection 260 comprising one of the descriptor values 308-k selected at a GUI element 312 accessible from a user interface 112. The descriptor selection 260 may be accessed by the descriptor selection component 222-3 via communication signals 114 received at the transceivers 160-b and transmitted from the client 170-d where the descriptor selection 260 was executed.

The logic flow 800 may generate personalized search results based on the descriptor selection for display on the user interface at block 808. For example, the search results personalization component 222-4 may generate personalized search results 280 based on a selected descriptor value 308-k, which may be displayed via a user interface 112 accessible by a display 172 coupled with a client 170-d.

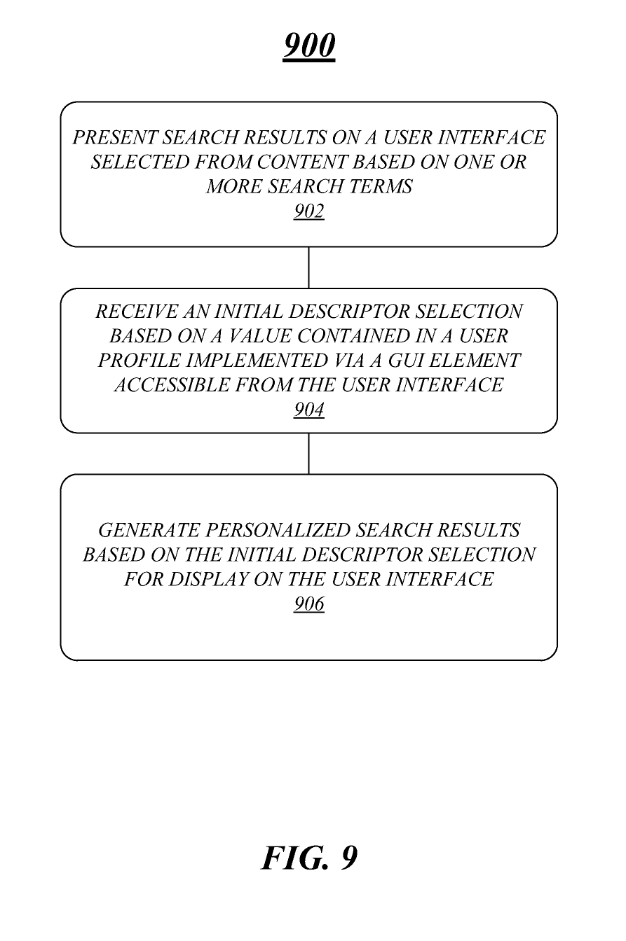

FIG. 9 illustrates one embodiment of a logic flow 900. The logic flow 900 may be representative of some or all of the operations executed by one or more embodiments described herein. For example, the logic flow 900 may illustrate operations performed by the user interface content personalization system 100.

The logic flow 900 may present search results on a user interface selected from content based on one or more search terms at block 902. For example, the content search component 222-2 may present search results 240-j on a user interface 112 comprising content 122-e relevant to search terms 302.

The logic flow 900 may receive an initial descriptor selection based on a value contained in a user profile implemented via a GUI element accessible from the user interface at block 904. For example, the descriptor selection component 222-2 may receive an initial descriptor selection 260 based on a value of a user profile descriptor 192-h corresponding to the values of the content descriptors 116-f utilized to configure the descriptor values 308-k. The descriptor selection 260 may be implemented at a GUI element 312 accessible from a user interface 112.

The logic flow 900 may generate personalized search results based on the descriptor selection for display on the user interface at block 906. For example, the search results personalization component 222-4 may generate personalized search results 280 based on an initial descriptor selection 260 executed automatically at a GUI element 312 based on a value stored in a user profile 182-g. The personalized search results 280 may be displayed via a user interface 112 accessible by a display 172 coupled with one of the clients 170-d.

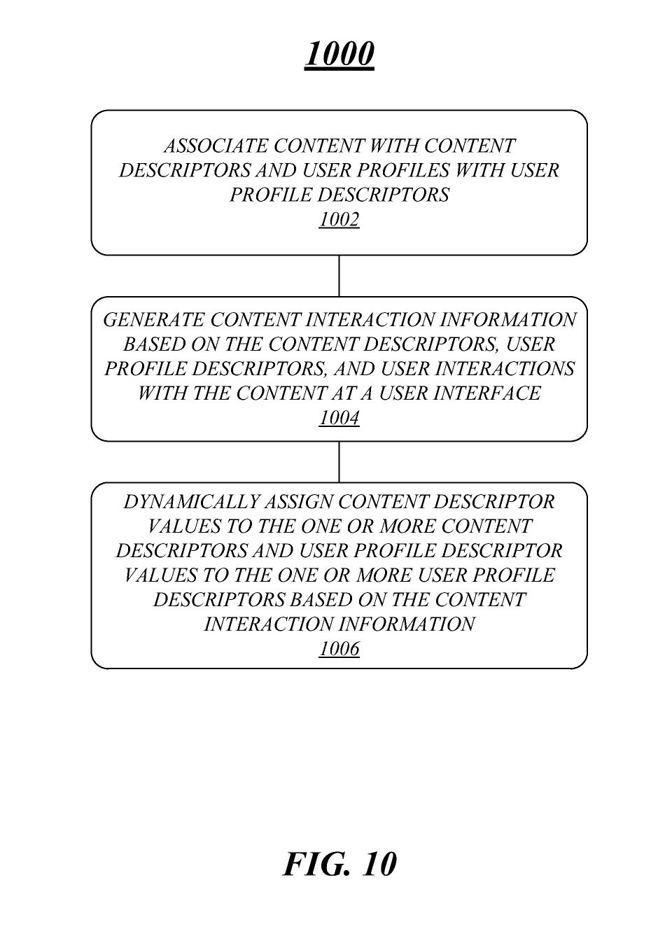

FIG. 10 illustrates one embodiment of a logic flow 1000. The logic flow 1000 may be representative of some or all of the operations executed by one or more embodiments described herein. For example, the logic flow 1000 may illustrate operations performed by the user interface content personalization system 100.

In the illustrated embodiment shown in FIG. 10, the logic flow 1000 may associate content with content descriptors and user profiles with user profile descriptors at block 1002. For example, the descriptor component 622-1 may associate content 122-e with content descriptors 116-f and user profiles 182-g with user profile descriptors 192-h stored on servers 120-c or clients 170-d and obtained by the servers 110-a through communication signals 114 received by the transceivers 160-b.

The logic flow 1000 may generate content interaction information based on the content descriptors, the user profile descriptors, and user interactions with the content at a user interface at block 1004. For instance, the content interaction component 622-2 may obtain content descriptors 116-f, user profile descriptors 192-h, and data involving user interactions with content 122-e on the user interface 112 received by the transceivers 160-b. The content interaction component 622-2 may use the user interaction data and values obtained from the content profile descriptors 116-f and the user profile descriptors 192-h to generate content interaction information.

The logic flow 1000 may generally operate to dynamically assign content descriptor values to the content descriptors and user profile descriptor values to the user profile descriptors based on the content interaction information at block 1006. For example, the descriptor value generator component 622-3 may dynamically assign values to the content descriptors 116-f and the user profile descriptors 192-h based on the content interaction information generated by the content interaction component 622-2.

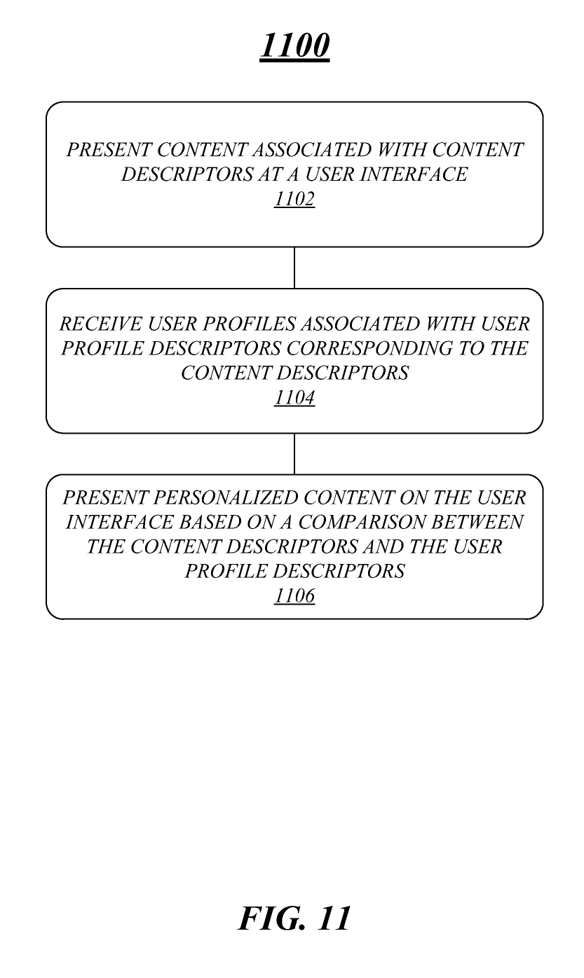

FIG. 11 illustrates one embodiment of a logic flow 1100. The logic flow 1100 may be representative of some or all of the operations executed by one or more embodiments described herein. For example, the logic flow 1100 may illustrate operations performed by the user interface content personalization system 100.

In the illustrated embodiment shown in FIG. 11, the logic flow 1100 may present content associated with content descriptors at a user interface at block 1102. For example, the user interface component 722-1 may present content 122-e associated with content descriptors 116-f at a user interface 112. The content 122-e may be accessed through a display 172 coupled with a client 170-d.

The logic flow 1100 may receive user profiles associated with user profile descriptors corresponding to the content descriptors at block 1104. For instance, the user profile component 722-2 may receive user profiles 182-g transmitted to the servers 110-a through the receivers 160-b. The user profiles 182-g may be associated with user profile descriptors 192-h that correspond with content descriptors 116-f of content 122-e presented on the user interface 112 by the user interface component 722-1.

The logic flow 1100 may present personalized content on the user interface based on a comparison between content values associated with the content descriptors and user profile values associated with the user profile descriptors at block 1106. For example, the content personalization component 722-3 may present personalized content 740 on the user interface 112 personalized based on a comparison between values of the content descriptors 116-f associated with the content 122-e and values of the user profile descriptors 192-h associated with users interacting with the content 122-e through a display 172 accessible through one of the clients 170-d.

FIG. 12 illustrates an embodiment of an exemplary computing architecture 1200 suitable for implementing various embodiments as previously described. In one embodiment, the computing architecture 1200 may comprise or be implemented as part of servers 110-a, servers 120-c, or clients 170-d.

As used in this application, the terms “system” and “component” are intended to refer to a computer-related entity, either hardware, a combination of hardware and software, software, or software in execution, examples of which are provided by the exemplary computing architecture 1200. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1200 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1200.

As shown in FIG. 12, the computing architecture 1200 comprises a processing unit 1204, a system memory 1206 and a system bus 1208. The processing unit 1204 can be any of various commercially available processors, such as those described with reference to the processor circuit 130 shown in FIG. 1.

The system bus 1208 provides an interface for system components including, but not limited to, the system memory 1206 to the processing unit 1204. The system bus 1208 can be any of several types of bus structure that may further interconnect to a memory bus (with or without a memory controller), a peripheral bus, and a local bus using any of a variety of commercially available bus architectures. Interface adapters may connect to the system bus 1208 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1200 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1206 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 12, the system memory 1206 can include non-volatile memory 1210 and/or volatile memory 1212. A basic input/output system (BIOS) can be stored in the non-volatile memory 1210.

The computer 1202 may include various types of computer-readable storage media in the form of one or more lower speed memory units, including an internal (or external) hard disk drive (HDD) 1214, a magnetic floppy disk drive (FDD) 1216 to read from or write to a removable magnetic disk 1218, and an optical disk drive 1220 to read from or write to a removable optical disk 1222 (e.g., a CD-ROM or DVD). The HDD 1214, FDD 1216 and optical disk drive 1220 can be connected to the system bus 1208 by a HDD interface 1224, an FDD interface 1226 and an optical drive interface 1228, respectively. The HDD interface 1224 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1210, 1212, including an operating system 1230, one or more application programs 1232, other program modules 1234, and program data 1236. In one embodiment, the one or more application programs 1232, other program modules 1234, and program data 1236 can include, for example, the various applications and/or components of the system 100.

A user can enter commands and information into the computer 1202 through one or more wire/wireless input devices, for example, a keyboard 1238 and a pointing device, such as a mouse 1240. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1204 through an input device interface 1242 that is coupled to the system bus 1208, but can be connected by other interfaces such as a parallel port, IEEE 1394 serial port, a game port, a USB port, an IR interface, and so forth.

A monitor 1244 or other type of display device is also connected to the system bus 1208 via an interface, such as a video adaptor 1246. The monitor 1244 may be internal or external to the computer 1202. In addition to the monitor 1244, a computer typically includes other peripheral output devices, such as speakers, printers, and so forth.

The computer 1202 may operate in a networked environment using logical connections via wire and/or wireless communications to one or more remote computers, such as a remote computer 1248. The remote computer 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wire/wireless connectivity to a local area network (LAN) 1252 and/or larger networks, for example, a wide area network (WAN) 1254. Such LAN and WAN networking environments are commonplace in offices and companies, and facilitate enterprise-wide computer networks, such as intranets, all of which may connect to a global communications network, for example, the Internet.

When used in a LAN networking environment, the computer 1202 is connected to the LAN 1252 through a wire and/or wireless communication network interface or adaptor 1256. The adaptor 1256 can facilitate wire and/or wireless communications to the LAN 1252, which may also include a wireless access point disposed thereon for communicating with the wireless functionality of the adaptor 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wire and/or wireless device, connects to the system bus 1208 via the input device interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

The various elements of the user interface content personalization system 100 as previously described with reference to FIGS. 1-12 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments; examples one through forty-six (1-46) provided below are intended to be exemplary and non-limiting.

In a first example, an apparatus comprises a transceiver; a processor circuit coupled to the transceiver; and a memory unit coupled to the processor circuit, the memory unit to store a content personalization application operative on the processor circuit to present personalized search results on a user interface based on a descriptor selection, the content personalization application comprising: a content descriptor component operative to associate content with one or more content descriptors; a content search component operative to present search results on a user interface, the search results being selected from the content based on one or more search terms; a descriptor selection component operative to receive a descriptor selection enabled by a graphical user interface element accessible from the user interface; and a search results personalization component operative to generate personalized search results based on the descriptor selection, the search results personalization component to provide personalized search results on the user interface without re-entry of the one or more search terms.

A second example comprises the apparatus described in the first example, wherein the one or more content descriptors are associated with a rating indicative of a technical difficulty level of the content.

A third example comprises the apparatus described in the first or second example, wherein the one or more content descriptors are associated with a category indicative of a genre of the content.

A fourth example comprises the apparatus described in any of the first through third examples, the content descriptor component operative to associate content comprising one or more web pages with the one or more content descriptors via one or more metadata tags.

A fifth example comprises the apparatus described in any of the first through fourth examples, the content personalization application comprising: a user profile component operative to receive one or more user profile descriptors corresponding to the one or more content descriptors from user profiles of users accessing the user interface; and a graphical user interface initial selection component operative to set an initial selection of the graphical user interface element to a corresponding value obtained from the one or more user profile descriptors.

A sixth example comprises the apparatus described in any of the first through fifth examples, the graphical user interface element comprising a slider graphical user interface element comprising one or more selection options corresponding to one or more values of the one or more content descriptors.

In a seventh example, a method comprises associating content, by a processor circuit, with one or more content descriptors; presenting search results on a user interface, the search results being selected from the content based on one or more search terms; receiving a descriptor selection by a transceiver coupled to the processor circuit, the descriptor selection being enabled by via a graphical user interface element accessible from the user interface; and generating personalized search results based on the descriptor selection for display on the user interface, the personalized search results being generated without re-entry of the one or more search terms.

An eighth example comprises the method of the seventh example, wherein the one or more content descriptors are associated with a rating indicative of a technical difficulty level of the content.

A ninth example comprises the method of the seventh or eighth examples, wherein the one or more content descriptors are associated with a category indicative of a genre of the content.

A tenth example comprises the method of any of the seventh through ninth examples, comprising associating content comprising one or more web pages with the one or more content descriptors via one or more metadata tags.

An eleventh example comprises the method of any of the seventh through tenth examples, comprising: receiving, by the transceiver, one or more user profile descriptors corresponding to the one or more content descriptors from user profiles of users accessing the user interface; and setting an initial selection of the graphical user interface element to a corresponding value obtained from the one or more user profile descriptors.

A twelfth example comprises the method of any of the seventh through eleventh examples, wherein the graphical user interface element comprises a slider graphical user interface element comprising one or more selection options corresponding to one or more values of the one or more content descriptors.

A thirteenth example comprises at least one machine-readable storage medium comprising a plurality of instructions that in response to being executed on a computing device, cause the computing device to carry out a method according to any of the seventh through twelfth examples.

In a fourteenth example, an apparatus comprises a transceiver; a processor circuit coupled to the transceiver; and a memory unit coupled to the processor circuit, the memory unit to store a content personalization application operative on the processor circuit to dynamically assign descriptor values for descriptors associated with user interface content and user profiles, the content personalization application comprising: a descriptor component operative to associate content with one or more content descriptors and user profiles with one or more user profile descriptors; a content interaction component operative to generate content interaction information based on the one or more content descriptors, one or more user profile descriptors, and user interactions with the content received by the transceiver; and a descriptor value generator component operative to dynamically assign content descriptor values to the one or more content descriptors and user profile descriptor values to the one or more user profile descriptors based on the content interaction information.

A fifteenth example comprises the apparatus of the fourteenth example, the descriptor component operative to assign a rating to each of the one or more content descriptors and each of the one or more user profile descriptors, the rating indicative of a technical difficulty level of the content and a technical proficiency associated with a user profile.

A sixteenth example comprises the apparatus of the fourteenth or fifteenth examples, the descriptor value generator component operative to assign content descriptor values to the one or more content descriptors utilizing content interaction information based on a crowd average rating of the content.

A seventeenth example comprises the apparatus of any of the fourteenth through sixteenth examples, the descriptor value generator component operative to assign content descriptor values to the one or more content descriptors utilizing content interaction information based on one or more browsing patterns at the user interface.

An eighteenth example comprises the apparatus of any of the fourteenth through seventeenth examples, the descriptor value generator operative to assign user profile values to one or more user profile descriptors based on an aggregate average of content values associated with the one or more content descriptors of content accessed through the user interface by users associated with the one or more user profiles.

A nineteenth example comprises the apparatus of any of the fourteenth through eighteenth examples, the descriptor component operative to associate content comprising one or more web pages with the one or more content descriptors via one or more metadata tags.

In a twentieth example, a method comprises associating, by a processor circuit accessible by a computing device, content with one or more content descriptors and user profiles with one or more user profile descriptors; generating content interaction information based on the one or more content descriptors, one or more user profile descriptors, and user interactions with the content received by a transceiver coupled to the processor circuit; and dynamically assigning content descriptor values to the one or more content descriptors and user profile descriptor values to the one or more user profile descriptors based on the content interaction information.

A twenty-first example comprises the method of the twentieth example, comprising assigning a rating to each of the one or more content descriptors and each of the one or more user profile descriptors, the rating indicative of a technical difficulty level of the content and a technical proficiency associated with a user profile.

A twenty-second example comprises the method of the twentieth or twenty-first examples, comprising assigning content values to the one or more content descriptors utilizing content interaction information based on a crowd average rating of the content.

A twenty-third example comprises the method of any of the twentieth through twenty-second examples, comprising assigning content descriptor values to the one or more content descriptors utilizing content interaction information based on one or more browsing patterns at the user interface.

A twenty-fourth example comprises the method of any of the twentieth through twenty-third examples, comprising assigning descriptor values to the one or more user profile descriptors utilizing content interaction information based on an aggregate average of the content descriptor values of content accessed through the user interface by users associated with the one or more user profiles.

A twenty-fifth example comprises the method of any of the twentieth through twenty-fourth examples, comprising associating content comprising one or more web pages with the one or more content descriptors via one or more metadata tags.

In a twenty-sixth example, at least one machine-readable storage medium comprising a plurality of instructions that in response to being executed on a computing device, cause the computing device to carry out a method according to the twentieth through twenty-fifth examples.

In a twenty-seventh example, an apparatus comprises a transceiver; a processor circuit coupled to the transceiver; and a memory unit coupled to the processor circuit, the memory unit to store a content personalization application operative on the processor circuit to present personalized content based on values associated with content descriptors and user profile descriptors, the content personalization application comprising: a user interface component operative to present content associated with one or more content descriptors on a user interface; a user profile component operative to receive, by the transceiver, one or more user profiles associated with one or more user profile descriptors corresponding to the one or more content descriptors; and a content personalization component operative to present personalized content on the user interface based on a comparison between content values associated with the one or more content descriptors and user profile values associated with the one or more user profile descriptors.

A twenty-eighth example comprises the apparatus of the twenty-seventh example, the user interface component operative to present content associated with one or more content descriptors comprising ratings configured as numerical values within a predetermined range.

A twenty-ninth example comprises the apparatus of the twenty-seventh or twenty-eighth examples, the content personalization component operative to present personalized content by matching ratings associated with the content with ratings associated with the one or more user profiles of users accessing the content through the user interface.

A thirtieth example comprises any of the apparatus of the twenty-seventh through twenty-ninth examples, the user interface component operative to present a user interface comprising a proprietary web site configured to limit access to the content to users associated with the one or more user profiles.

A thirty-first example comprises any of the apparatus of the twenty-seventh through thirtieth examples, the user interface component operative to present the proprietary web site as a technical support web site comprised of content associated with one or more content descriptors indicating a technical difficulty of the content.

In a thirty-second example, a method comprises presenting content, by a processor circuit of a computing device, associated with one or more content descriptors on a user interface; receiving, by a transceiver coupled with the processor circuit, one or more user profiles associated with one or more user profile descriptors corresponding to the one or more content descriptors; and presenting personalized content on the user interface based on a comparison between content values associated with the one or more content descriptors and user profile values associated with the one or more user profile descriptors.

A thirty-third example comprises the method of the thirty-second example, comprising presenting content associated with one or more content descriptors comprising ratings configured as numerical values within a predetermined range.

A thirty-fourth example comprises the method of the thirty-second or thirty-third examples, comprising presenting personalized content by matching ratings associated with the content with ratings associated with the one or more user profiles of users accessing the content through the user interface.

A thirty-fifth example comprises any of the methods of the thirty-second through thirty-fifth examples, comprising presenting a user interface comprising a proprietary web site configured to limit access to the content to users associated with the one or more user profiles.

A thirty-sixth example comprises any of the methods of the thirty-second through thirty-sixth examples, comprising presenting the proprietary web site as a technical support web site comprised of content associated with one or more content descriptors indicating a technical difficulty of the content.

In a thirty-seventh example, at least one machine-readable storage medium comprising a plurality of instructions that in response to being executed on a computing device, cause the computing device to carry any of the methods of the thirty-second through thirty-sixth examples.

In a thirty-eighth example, an apparatus comprises a transceiver; a processor circuit coupled to the transceiver; and a memory unit coupled to the processor circuit, the memory unit to store a content personalization application operative on the processor circuit to present personalized search results on a user interface based on a descriptor selection, the content personalization application comprising: a content descriptor component operative to access content associated with one or more content descriptors; a content search component operative to receive search results for display on a user interface, the search results selected from the content based on one or more search terms entered at the user interface; a descriptor selection component operative to assign a descriptor selection via a graphical user interface element accessible from the user interface; and a search results personalization component operative to receive personalized search results based on the descriptor selection for display on the user interface, the search results personalization component to present personalized search results on the user interface without re-entry of the one or more search terms.

A thirty-ninth example comprises the apparatus of the thirty-eighth example, the content descriptor component operative to access the content utilizing at least one of a web browser application and a thin-client application.

A fortieth example comprises the apparatus of the thirty-eighth or thirty-ninth examples, the content personalization application comprising: a user profile component operative to provide one or more user profile descriptors corresponding to the one or more content descriptors from user profiles associated with users accessing the user interface; a graphical user interface initial selection component operative to set an initial selection of the graphical user interface element to a corresponding value obtained from the one or more user profile descriptors.

A forty-first example comprises any of the apparatus of the thirty-eighth to fortieth examples the graphical user interface element comprising a slider graphical user interface element comprising one or more selection options corresponding to one or more values of the one or more content descriptors.

In a forty-second example, a method comprises accessing content, by a processor circuit, associated with one or more content descriptors; receiving search results, by a transceiver coupled to the processor circuit, for display on a user interface, the search results selected from the content based on one or more search terms entered at the user interface; assigning a descriptor selection via a graphical user interface element accessible from the user interface; and receiving personalized search results based on the descriptor selection for display on the user interface, the personalized search results being received without re-entry of the one or more search terms.

A forty-third example comprises the method of the forty-second example, comprising accessing the content utilizing at least one of a web browser application and a thin-client application.

A forty-fourth example comprises the methods of the forty-second or forty-third examples, comprising: providing one or more user profile descriptors corresponding to the one or more content descriptors from user profiles of users accessing the user interface; and setting an initial selection of the graphical user interface element to a corresponding value obtained from the one or more user profile descriptors.

A forty-fifth example comprises any of the methods of the forty-second to forty-fourth examples, wherein the graphical user interface element comprises a slider graphical user interface element comprising one or more selection options corresponding to one or more values of the one or more content descriptors.

In a forty-sixth example, at least one machine-readable storage medium comprises a plurality of instructions that in response to being executed on a computing device, cause the computing device to carry out a method according to any of the forty-second to forty-fifth examples.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a transceiver;
a processor circuit coupled to the transceiver; and
a memory unit coupled to the processor circuit, the memory unit to store a content personalization application operative on the processor circuit to present personalized search results on a user interface based on a descriptor selection, the content personalization application comprising:
a content descriptor component operative to associate content with one or more content descriptors;
a content search component operative to present search results on a user interface, the search results being selected from the content based on one or more search terms;
a descriptor selection component operative to receive a descriptor selection enabled by a graphical user interface element accessible from the user interface; and
a search results personalization component operative to generate personalized search results based on the descriptor selection, the search results personalization component to provide personalized search results on the user interface without re-entry of the one or more search terms.

2. The apparatus of claim 1, wherein the one or more content descriptors are associated with a rating indicative of a technical difficulty level of the content.

3. The apparatus of claim 1, wherein the one or more content descriptors are associated with a category indicative of a genre of the content.

4. The apparatus of claim 1, the content descriptor component operative to associate content comprising one or more web pages with the one or more content descriptors via one or more metadata tags.

5. The apparatus of claim 1, the content personalization application comprising:
a user profile component operative to receive one or more user profile descriptors corresponding to the one or more content descriptors from user profiles associated with users accessing the user interface; and
a graphical user interface initial selection component operative to set an initial selection of the graphical user interface element to a corresponding value obtained from the one or more user profile descriptors.

6. The apparatus of claim 1, the graphical user interface element comprising a slider graphical user interface element comprising one or more selection options corresponding to one or more values of the one or more content descriptors.

7. A method, comprising:
associating content, by a processor circuit, with one or more content descriptors;
presenting search results on a user interface, the search results being selected from the content based on one or more search terms;
receiving a descriptor selection by a transceiver coupled to the processor circuit, the descriptor selection being enabled by a graphical user interface element accessible from the user interface; and
generating personalized search results based on the descriptor selection for display on the user interface, the personalized search results being generated without re-entry of the one or more search terms.

8. The method of claim 7, wherein the one or more content descriptors are associated with a rating indicative of a technical difficulty level of the content.

9. The method of claim 7, wherein the one or more content descriptors are associated with a category indicative of a genre of the content.

10. The method of claim 7 comprising associating content comprising one or more web pages with the one or more content descriptors via one or more metadata tags.

11. The method of claim 7, comprising:
receiving, by the transceiver, one or more user profile descriptors corresponding to the one or more content descriptors from user profiles of users accessing the user interface; and
setting an initial selection of the graphical user interface element to a corresponding value obtained from the one or more user profile descriptors.

12. The method of claim 7, wherein the graphical user interface element comprises a slider graphical user interface element comprising one or more selection options corresponding to one or more values of the one or more content descriptors.

13. At least one machine-readable storage medium comprising a plurality of instructions that in response to being executed on a computing device, cause the computing device to:
associate content, by a processor circuit, with one or more content descriptors;
present search results on a user interface, the search results being selected from the content based on one or more search terms;
receive a descriptor selection by a transceiver coupled to the processor circuit, the descriptor selection being enabled by a graphical user interface element accessible from the user interface; and
generate personalized search results based on the descriptor selection for display on the user interface, the personalized search results being generated without re-entry of the one or more search terms.

14-46. (canceled)

47. The at least one machine-readable storage medium of claim 13, the one or more content descriptors are associated with a rating indicative of a technical difficulty level of the content.

48. The at least one machine-readable storage medium of claim 13, the one or more content descriptors are associated with a category indicative of a genre of the content.

49. The at least one machine-readable storage medium of claim 13, the computing device caused to associate content comprising one or more web pages with the one or more content descriptors via one or more metadata tags.

50. The at least one machine-readable storage medium of claim 13, the computing device caused to:
receive one or more user profile descriptors corresponding to the one or more content descriptors from user profiles associated with users accessing the user interface; and
set an initial selection of the graphical user interface element to a corresponding value obtained from the one or more user profile descriptors.

51. The at least one machine-readable storage medium of claim 13, the graphical user interface element comprising a slider graphical user interface element comprising one or more selection options corresponding to one or more values of the one or more content descriptors.
